(19) United States
(12) Patent Application Publication
(10) Pub. No.: US 2022/0114445 A1
(43) Pub. Date: Apr. 14, 2022

(54) METHOD AND SYSTEM FOR PROCESSING NEURAL NETWORK PREDICTIONS IN THE PRESENCE OF ADVERSE PERTURBATIONS

(71) Applicant: IEE INTERNATIONAL ELECTRONICS & ENGINEERING S.A., ECHTERNACH (LU)

(72) Inventors: Hans-Peter BEISE, Perl (DE); Udo SCHRÖDER, Föhren (DE); Steve DIAS DA CRUZ, Mertert (LU); Jan SOKOLOWSKI, Pellingen (DE)

(21) Appl. No.: 17/420,776

(22) PCT Filed: Jan. 3, 2020
(86) PCT No.: PCT/EP2020/050083

§ 371 Date: Jul. 6, 2021

(30) Foreign Application Priority Data
Jan. 4, 2019 (LU) LI101088

(51) Int. Cl. G06N 3/08; G05B 13/02

(52) U.S. Cl. CPC G06N 3/08; G05B 13/025; G05B 13/027

(57) ABSTRACT

A system and method for processing predictions in the presence of adversarial perturbations in a sensing system. The processor receives inputs from sensors and runs a neural network having a network function that generates, as outputs, predictions of the neural network. The method generates from a plurality of outputs a measurement quantity (m) that may be, at or near a given input, either (i) a first measurement quantity M₁ corresponding to a gradient of the given output, (ii) a second measurement quantity M₂ corresponding to a gradient of a predetermined objective function derived from a training process for the neural network, or (iii) a third measurement quantity M₃ derived from a combination of M₁, and M₂. The method determines whether the measurement quantity (m) is equal to or greater than a threshold. If greater than the threshold, one or more remedial actions are performed to correct for a perturbation.

### TECHNICAL FIELD

The present invention generally relates to the detection in sensing systems based on neural networks. More particularly, the present invention relates to sensing and/or classifying method and system, for processing predictions and/or classifications in the presence of adversarial perturbations.

### BACKGROUND

The present invention finds application in any sensing system, as for example used in the automotive sector, which employs a neural network (NN) for classification/prediction purposes.

As is known, neural network models can be viewed as mathematical models defining a function f: X→Y. It is known in the art that, besides the great potential of (deep-)neural networks, these functions are vulnerable to adversarial perturbations (c.f. Szegedy, C., Zaremba, W., Sutskever, I., Bruna, J., Erhan, D., Goodfellow, I., & Fergus, R. (2013). Intriguing properties of neural networks. arXiv preprint arXiv:1312.6199). That is, correctly classified samples can be slightly perturbed in a way that the classification changes tremendously and becomes wrong. Such perturbations can be the result of an adversarial attack, but they can also occur by chance. Hence, it is necessary, in particular for safety critical applications, to have mechanisms to detect such perturbed inputs in order to interpret the corresponding classification accordingly.

The role of a derivative of the network function with respect to the input has been discussed in (i) Hein, M., & Andriushchenko, M. (2017). Formal guarantees on the robustness of a classifier against adversarial manipulation. In Advances in Neural Information Processing Systems (pp. 2266-2276, and in (ii) Simon-Gabriel, C. J., 011ivier, Y., Schölkopf, B., Bottou, L., & Lopez-Paz, D. (2018). Adversarial Vulnerability of Neural Networks Increases With Input Dimension. arXiv preprint arXiv:1802.01421.

### SUMMARY

A problem addressed by the present invention is how to provide effective neural network-based sensing and/or classifying methods and systems that reduce or eliminate the effects of the presence of adversarial perturbations upon predictions and/or classifications.

In order to overcome the abovementioned problems, in one aspect there is provided a method of processing predictions in the presence of adversarial perturbations in a sensing system comprising a processor and, coupled thereto, a memory. It should be noted that in the context of the invention the expressions “processor” and “memory” are not limited to specific implementations of the processing environment. The processor and memory may e.g. be standard processors used in computers or common computing devices. On the other hand, the skilled person will appreciate that a neural network may implemented in some other hardware device that might be dedicated to neural networks (devices with a network structure burned into their circuitry are expected to be available in the future). These and other possible implementations of “processor” and “memory” devices are also encompassed by the expressions.

The processor may be configured to connect to one or more sensors for receiving inputs (x) therefrom. The processor may be configured to run a module in the memory for implementing a neural network. The neural network may have a network function f_{θ}, where θ are network parameters. The method may be executed by the processor and comprise generating, from the inputs (x) including at least a given input (x₀), respective outputs, the outputs being predictions of the neural network and including a given output y corresponding to the given input (x₀), where y=f_{θ} (x₀). The method may further comprise generating, from a plurality of outputs including the given output y, a measurement quantity (m). The measurement quantity m may be, at or near the given input (x₀), (i) a first measurement quantity M₁ corresponding to a gradient of the given output y, (ii) a second measurement quantity M₂ corresponding to a gradient of a predetermined objective function derived from a training process for the neural network, or (iii) a third measurement quantity M₃ derived from a combination of M₁ and M₂. The method may further comprise determining whether the measurement quantity (m) is equal to or greater than a threshold. The method may further comprise, if the measurement quantity (m) is determined to be equal to or greater than the threshold, performing one or more remedial actions to correct for a perturbation.

Preferably, the method further comprises, if the measurement quantity (m) is determined to be less than the threshold, performing a predetermined usual action resulting from y.

In an embodiment, generating the first measurement quantity M₁ comprises: computing a gradient Dₓf_{θ} of the network function f_{θ} with respect to the input (x); and deriving the first measurement quantity M₁ as the value of gradient Dₓf_{θ} corresponding to the given input (x₀). Preferably, deriving the first measurement quantity M₁ comprises determining the Euclidean norm of Dₓf_{θ} corresponding to the given input (x₀).

In an embodiment, generating the second measurement quantity M₂ comprises: computing a gradient D_{θ} J(X,Y, f_{θ}) of the objective function by J(X,Y,f_{θ}) with respect to the network parameters f_{θ}, whereby J(X,Y, f_{θ}) has been previously obtained by calibrating the network function f_{θ} in an offline training process based on given training data; and deriving the second measurement quantity M₂ as the value of gradient D_{θ} J(X,Y,f_{θ}) corresponding to the given input (x₀). Preferably, deriving the second measurement quantity M₂ comprises determining the Euclidean norm of D_{θ} J(X,Y,f_{θ}) corresponding to the given input (x₀).

In embodiments, the third measurement quantity M₃ is computed as a weighted sum of the first measurement quantity M₁ and the second measurement quantity M₂.

The first measurement quantity M₁, the second measurement quantity M₂ and/or the third measurement quantity M₃ may be generated based on a predetermined neighborhood of inputs (x) including the given input (x₀). Preferably, the predetermined neighborhood of inputs includes a first plurality of inputs prior to the the given input (x₀) and/or a second plurality of inputs after the the given input (x₀). Preferably, the number in the first plurality and/or the second plurality is 2-10, more preferably 2-5, more preferably 2-3.

In an embodiment, the one or more remedial actions comprise saving the value of f_{θ}(x₀) and wait for a next output f_{θ}(x₁) in order to verify f_{θ}(x₀) or to determine that it was a false output.

In an embodiment, the sensing system includes one or more output devices, and the one or more remedial actions comprise stopping the sensing system and issuing a corresponding warning notice via an output device.

In an embodiment, the one or more remedial actions comprise rejecting the prediction f_{θ}(x₀) and stopping any predetermined further actions that would result from that prediction.

According to another aspect, there is provided a method of classifying outputs of a sensing system employing a neural network, the method comprising, if the measurement quantity (m) is determined to be less than the threshold, performing a predetermined usual action resulting from y, wherein the predetermined usual action or the predetermined further actions comprise determining a classification or a regression based on the prediction y.

Preferably, the sensing system includes one or more output devices and one or more input devices, and wherein the method further comprises: outputting via an output device a request for a user to approve or disapprove a determined classification, and receiving a user input via an input device, the user input indicating whether the determined classification is approved or disapproved.

According to another aspect, there is provided a sensing and/or classifying system, for processing predictions and/or classifications in the presence of adversarial perturbations, the sensing and/or classifying system comprising: a processor and, coupled thereto, a memory, wherein the processor is configured to connect to one or more sensors for receiving inputs (x) therefrom, wherein the processor is configured to run a module in the memory for implementing a neural network, the neural network having a network function f_{θ}, where θ are network parameters, and wherein the processor, is configured to execute one or more embodiments of the method as described above.

According to another aspect of the invention there is provided a vehicle comprising a sensing and/or classifying system as described above.

The invention, at least in some embodiments, provides a method that supports the robustness and safety of systems that implement a neural network for classification purposes. To this end, a method is formulated to measure whether a sample at hand (x₀) might be located in a region of the input space where the neural network does not perform in a reliable manner. Beneficially, the disclosed techniques exploit the analytical properties of the neural network. More precisely, the disclosed techniques implement the gradients of the neural network which then deliver sensitivity information about the decision at a given sample.

An advantage of the invention, at least in some embodiments, is to reduce or eliminate the effects of the presence of adversarial perturbations upon predictions and/or classifications.

A further advantage of the invention, at least in some embodiments, is that by deriving analytical characteristics from the neural network, determination of whether the neural network might have had difficulties in performing a reliable prediction is enabled.

Yet further advantages of the invention, at least in some embodiments, include the following: (i) analytical properties of neural network-function may be used to measure reliability; (ii) two measures based on gradients of the neural network and on the underlying objective function used during training, are employed and can be combined to a common criterion for reliability; (iii) robustness measures are tailored to the actual neural network (directly based on the actual neural network); and (iv) the technique is applicable to any domain where neural networks are employed.

### BRIEF DESCRIPTION OF THE DRAWINGS

Further details and advantages of the present invention will be apparent from the following detailed description of not limiting embodiments with reference to the attached drawing, wherein:

FIG. 1 is a schematic block diagram of a neural network-based sensing and/or classifying system according to an embodiment of the invention; and

FIG. 2 schematically represents the operation of the neural network-based sensing and/or classifying system of FIG. 1.

### DETAILED DESCRIPTION

In the drawings, like reference numerals have been used to denote like elements. Any features, components, operations, steps or other elements of one embodiment may be used in combination with those of any other embodiment disclosed herein, unless indicated otherwise hereinbelow.

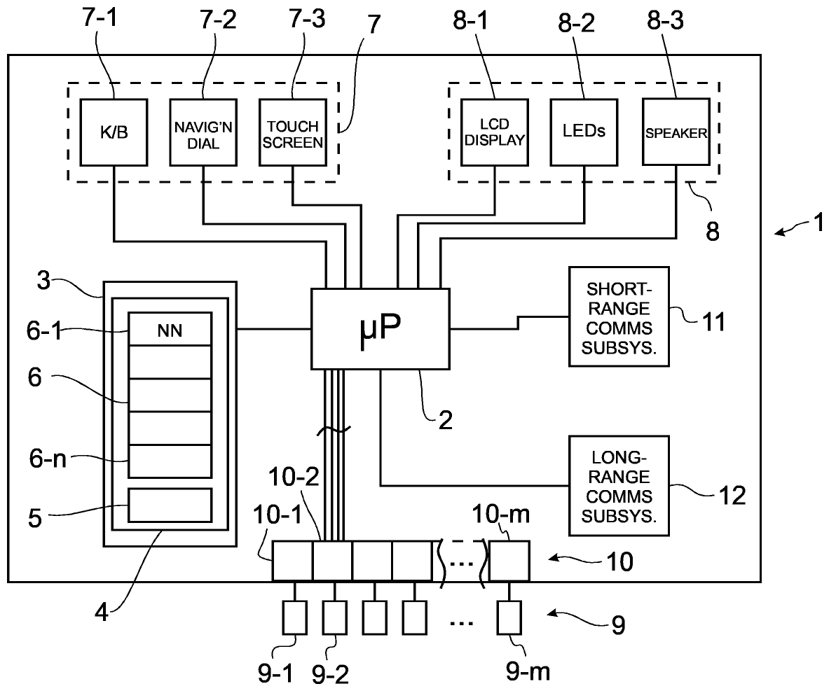

FIG. 1 is a schematic block diagram of a neural network-based sensing and/or classifying system 1 (hereafter also “system”) according to an embodiment of the invention.

The system 1 includes a processor 2 and, coupled thereto, one or memories including non-volatile memory (NVM) 3. In the NVM 3 may be stored various software 4 including operating system software 5 and/or one or more software modules 6-1 to 6-n (collectively modules 6). The modules 6 may include a neural network module 6-1 implementing a neural network, as discussed further hereinbelow.

In embodiments, for the purpose of interaction with a user, the system 1 may include one or more input devices 7 and one or more output devices 8. The input devices 7 may include a keyboard or keypad 7-1, a navigation dial or knob/button 7-2 and/or a touchscreen 7-3. The output devices 8 may include a display (e.g. LCD) 8-1, one or more illuminable indicators (e.g. LEDs) 8-2 and/or an audio output device (e.g. speaker) 8-3.

During operation of the neural network module 6-1, the processor 2 may receive input from one or more sensors 9-1, 9-2, . . . , 9-m (collectively sensors 9), for example via respective interfaces 10-1, 10-2, . . . , 10-m (collectively interfaces 10), which are thereafter further processed as discussed in more detail below.

Optionally, the system 1 includes a short-range (e.g. Bluetooth, ZigBee) communications subsystem 11 and/or a long-range (e.g. cellular, such as 4G, 5G) communications subsystem 12, each interface being for receipt and/or transmission of sensor or other data, control parameters, training data, or other system-related data, or for transmission of neural network predictions and/or classifications.

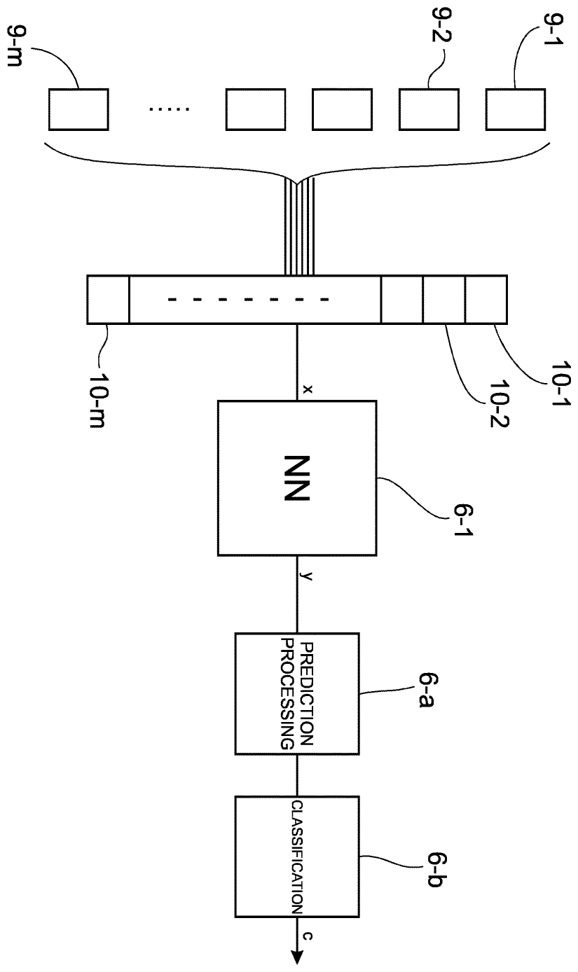

FIG. 2 schematically represents the operation of the neural network-based sensing and/or classifying system of FIG. 1.

Received at the neural network module 6-1 are successive inputs or samples x, received from sensors 9 via interfaces 10. In embodiments, the neural network module 6-1 may receive the inputs x as raw data, or as pre-processed sensor data through an appropriate pre-processing technique, such as amplification, filtering or other signal conditioning. While denoted simply as x, it will be appreciated that the inputs x may be in the form of signals disposed in an array or matrix corresponding to the configuration of sensors 9.

The underlying principles of the disclosed techniques will be discussed in the following.

For the purpose of illustration, under consideration is a general sensing system that receives data from one or several sensors 9. The system employs a neural network (NN) module 6-1 to make a prediction or classification regarding the environment or some physical quantity.

As an example, the following automotive and other scenarios are envisaged:
Interior RADAR system (for vital signs);
LIDAR, Camera and RADAR for exterior object detection;
Camera based gesture recognition;
Driver monitoring system; and
Ultrasonic based systems.

It is further assumed that the system (NN module 6-1) uses a NN denoted by f₇₄ (with θ being the network parameters) that receives the raw or pre-processed sensor data (from one or several sensors 9), denoted by x, upon which it performs a prediction or classification.

Returning to the abovementioned example scenarios, the classification/prediction might be as follows:
Interior RADAR system (for vital signs)->small baby is present in the car;
LIDAR, Camera and RADAR for exterior object detection->cyclist detected;
Camera based gesture recognition->gesture with intension to start a phone call detected;
Driver monitoring system->driver is under influence of drugs; and/or
Ultrasonic based systems->environment recognition.

It is assumed that f_{θ} has been calibrated in an offline training process (based on given training data). This training process is (as it is usually done) performed by solving an optimization problem (fit training data to desired output) that is formulated by means of a certain objective function denoted by J(X,Y,f_{θ}). Here X denotes the set of training data and Y are the corresponding labels (desired output).

In use, the NN module 6-1 is operative, for each input by x, to generate or determine a corresponding output, so for a given input x₀ a given output y is determined as y=f_{θ} (x₀).

Returning to FIG. 2, in accordance with embodiments, further processing and/or evasive/remedial action is carried out by prediction processing module 6-a (from modules 6 in FIG. 1), based on the given output y and making use of one or more measurement quantities, as discussed further below. As seen in FIG. 2, depending on further determinations/operation based on the given output y and the one or more measurement quantities, a classification stage 6-b (e.g. from modules 6 in FIG. 1) may be operable to perform a classification based on the output from the NN module 6-1. The various embodiments and actions are discussed in the following.

In embodiments of the present invention, two characteristics of f₇₄ and J(X,Y,f_{θ}) that can be used in parallel or separately are defined and employed.

In a first embodiment, the gradient of the network function f₇₄ with respect to the input x, which is denoted by Dₓf_{θ}, is used.

Here, it is noted that, given an actual input x₀ during life-time (of operation of system 1), the magnitude of the entries in the gradient Dₓf_{θ}(x₀) scales with the sensitivity of the classification in the neighbourhood of the sample x₀. In other words, the higher the entries Dₓf_{θ}(x₀) the more the output f_{θ}(x₀+δ) will change for certain perturbations δ. This in turn provides information that allows the determination of whether the input region around the sample x₀ constitutes a region of high fluctuation in the classification or not. This gives information about the reliability of the output f_{θ}(x₀).

In this first embodiment, therefore, a suitable quantity is derived from Dₓf_{θ}(x₀) denoted by M₁(Dₓf_{θ}(x₀)) (with, for instance, M₁ the Euclidean norm). If this quantity exceeds a predefined threshold, then the system can react accordingly (concrete reactions are formulated below).

In a second embodiment, there is employed D_{θ} J(X,Y,f_{θ})—the gradient of the objective function with respect to the network parameters θ.

Here, given an actual input x₀ during life-time and the corresponding output f_{θ}(x₀)=y₀, the magnitude of the entries in the gradient D_{eθ} J(x₀, y₀, f_{θ}) provides information about whether the system would have learned something when the pair (x₀, y₀) would have been part of the training data. That is, the higher the entries in D_{θ} J(x₀, y₀, f_{θ}) the more the system could have learned from (x₀, y₀). This in turn allows it to be concluded whether there has been sufficient training data in that input region and whether the system should be capable or not to classify the latter with a sufficiently high confidence. The underlying assumption is that an adversarial perturbation would have given information (high entries in D_{eθ} J(x₀, y₀, f_{θ})) to the training process.

In this second embodiment, therefore, a quantity M₂(D_{θ} J(x₀, y₀, f_{θ})) derived from D_{θ} J(x₀, y₀, f_{θ})) is used to quantify to what extent one can trust the output f_{θ}(x₀). Such quantity M₂ could for instance be the Euclidean norm or any other mathematical mapping to a size or length. If this quantity exceeds a predefined threshold, the system can react accordingly.

Both measures M₁, M₂ can also be evaluated in a reasonable neighbourhood around the sample x₀. For example, a predetermined number of values obtained for samples (inputs) prior to and/or after input x₀ may be used.

If one or two of the proposed measures M₁, M₂ indicate that the prediction f_{θ}(x₀) is not reliable, then, in embodiments the following are remedial/evasive actions that may be executed:
Reject the prediction f_{θ}(x₀) and stop any further actions that would result from it (for instance classification);
Save the value of f_{θ}(x₀) and wait for a next output f_{θ}(x₁) in order to falsify or verify f_{θ}(x₀);
Stop the whole system and issue a corresponding warning notice; and/or
Ask a potential user to approve the classification.

For illustration, let M(x, f_{θ}) be one of the introduced quantities M₁(Dₓf_{θ}(x₀)), M₂(D_{θ} J(x₀, y₀, f_{θ})), a combination (like weighted sum) of the latter, or any other useful mapping. Then a pseudocode of the system may be as follows:

While live-time of the system

receive sensor data x
y ← f_{θ}(x)
m ← M(x, f_{θ})
if m < confidence threshold then

perform usual action resulting from y

else

perform an evasive action

end

end

While embodiments have been described by reference to embodiments of survey devices having various components in their respective implementations, it will be appreciated that other embodiments make use of other combinations and permutations of these and other components.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Thus, while there has been described what are believed to be the preferred embodiments of the invention, those skilled in the art will recognize that other and further modifications may be made thereto without departing from the scope of the invention as defined by the claims, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of processing predictions in the presence of adversarial perturbations in a sensing system comprising a processor and, coupled thereto, a memory, the processor being configured to connect to one or more sensors for receiving inputs (x) therefrom, the processor being configured to run a module in the memory for implementing a neural network, the neural network having a network function f_{θ}, where θ are network parameters, the method being executed by the processor and comprising:
generating, from the inputs (x) including at least a given input (x₀), respective outputs, the outputs being predictions of the neural network and including a given output y₀ corresponding to the given input (x₀), where y₀=f_{θ} (x₀);
generating, from a plurality of outputs including the given output y₀, a measurement quantity (m), where m is, at or near the given input (x₀), (i) a first measurement quantity M₁ as a value of a gradient Dₓf_{θ} of the network function f_{θ} corresponding to the given input (x₀), (ii) a second measurement quantity M₂ corresponding to a gradient of a predetermined objective function derived from a training process for the neural network, or (iii) a third measurement quantity M₃ derived from a combination of M₁ and M₂;
determining whether the measurement quantity (m) is equal to or greater than a threshold, and
if the measurement quantity (m) is determined to be equal to or greater than the threshold, performing one or more remedial actions to correct for a perturbation.

2. The method according to claim 1, further comprising, if the measurement quantity (m) is determined to be less than the threshold, performing a predetermined usual action resulting from y.

3. The method according to claim 1, wherein generating the first measurement quantity M₁ comprises:
computing the gradient Dₓf_{θ} of the network function f₇₄ with respect to the input (x), and
deriving the first measurement quantity M₁ as the value of gradient Dₓf_{θ} corresponding to the given input (x₀).

4. The method according to claim 3, wherein deriving the first measurement quantity M₁ comprises determining the Euclidean norm of Dₓf_{θ} corresponding to the given input (x₀).

5. The method according to claim 1, wherein generating the second measurement quantity M₂ comprises:
computing a gradient D_{θ} J(X,Y,f_{θ}) of the objective function by J(X,Y,f_{θ}) with respect to the network parameters θ, whereby J(X,Y, f_{θ}) has been previously obtained by calibrating the network function f₇₄ in an offline training process based on given training data; and
deriving the second measurement quantity M₂ as the value of gradient D_{θ} J(X,Y,f_{θ}) corresponding to the given input (x₀).

6. The method according to claim 5, wherein deriving the second measurement quantity M₂ comprises determining the Euclidean norm of D_{θ} J(X,Y,f_{θ}) corresponding to the given input (x₀).

7. The method according to claim 1, wherein the third measurement quantity M₃ is computed as a weighted sum of the first measurement quantity M₁ and the second measurement quantity M₂.

8. The method according to claim 1, wherein the first measurement quantity M₁, the second measurement quantity M₂ and/or the third measurement quantity M₃ is generated based on a predetermined neighborhood of inputs (x) including the given input (x₀).

9. The method according to claim 8, wherein the predetermined neighborhood of inputs includes a first plurality of inputs prior to the given input (x₀) and/or a second plurality of inputs after the given input (x₀).

10. The method according to claim 9, wherein the number in the first plurality and/or the second plurality is 2-10, more preferably 2-5, more preferably 2-3.

11. The method according to claim 1, wherein the one or more remedial actions comprise saving the value of f_{θ}(x₀) and wait for a next output f_{θ}(x₁) in order to verify f_{θ}(x₀) or to determine that it was a false output.

12. The method according to claim 1, wherein the sensing system includes one or more output devices, and the one or more remedial actions comprise stopping the sensing system and issuing a corresponding warning notice via an output device.

13. The method according to claim 1, wherein the one or more remedial actions comprise rejecting the prediction f_{θ}(x₀) and stopping any predetermined further actions that would result from that prediction.

14. A method of classifying outputs of a sensing system employing a neural network, the method comprising the method according to claim 2, wherein the predetermined usual action or the predetermined further actions comprise determining a classification or a regression based on the prediction y.

15. The method according to claim 14, wherein the sensing system includes one or more output devices and one or more input devices, and wherein the method further comprises:
outputting via an output device a request for a user to approve or disapprove a determined classification, and
receiving a user input via an input device, the user input indicating whether the determined classification is approved or disapproved.

16. A sensing and/or classifying system, for processing predictions and/or classifications in the presence of adversarial perturbations, the sensing and/or classifying system comprising:
a processor and, coupled thereto,
a memory,
wherein the processor is configured to connect to one or more sensors for receiving inputs (x) therefrom,
wherein the processor is configured to run a module in the memory for implementing a neural network, the neural network having a network function f_{θ}, where θ are network parameters, and
wherein the processor, is configured to execute the method of claim 1,.

17. A vehicle comprising a sensing and/or classifying system according to claim 16.
